(19) United States
(12) Patent Application Publication
(10) Pub. No.: US 2023/0289617 A1
(43) Pub. Date: Sep. 14, 2023

(54) METHOD AND APPARATUS FOR LEARNING GRAPH REPRESENTATION FOR OUT-OF-DISTRIBUTION GENERALIZATION, DEVICE AND STORAGE MEDIUM

(71) Applicant: Tsinghua University, Beijing (CN)

(72) Inventors: Wenwu ZHU, Beijing (CN); Xin WANG, Beijing (CN); Haoyang LI, Beijing (CN)

(73) Assignee: Tsinghua University, Beijing (CN)

(21) Appl. No.: 18/096,021

(22) Filed: Jan. 12, 2023

(30) Foreign Application Priority Data
Mar. 8, 2022 (CN) 202210227151.5

(51) Int. Cl. G06N 3/0985; G06N 3/045

(52) U.S. Cl. CPC G06N 3/0985; G06N 3/045

(57) ABSTRACT

A method and apparatus for learning graph representations for out-of-distribution generalization. The method includes: inputting an original graph dataset into a graph structured data representation network; identifying a stable subgraph and a noise subgraph; obtaining a vectorized representation of the stable subgraph and a vectorized representation of the noise subgraph by performing representation processing on the identified graph structured data; simulating a multi-distribution environment, and obtaining a corresponding prediction result by predicting in the multi-distribution environment according to the vectorized representation of the stable subgraph; calculating a loss function based on the prediction result and a label of the original graph structured data, performing parameter optimization on the graph structured data representation network, and obtaining a graph structured data representation model; and executing a graph data-related task by using the graph structured data representation model, and obtaining a target result of the graph data-related task.

### CROSS-REFERENCE TO THE RELATED APPLICATION

The present application claims priority to Chinese Patent Application No. 202210227151.5, filed on Mar. 8, 2022, the entire disclosure of which is incorporated herein by reference.

### TECHNICAL FIELD

Embodiments of the present application relate to the technical field of data processing, and in particular, to a method and apparatus for learning graph representations for out-of-distribution generalization, a device and a storage medium.

### BACKGROUND

Graph structured data is data in a graph form composed of nodes and edges, for example, social networks, traffic networks and biological networks. Such graph structured data cannot be directly applied to most of deep learning algorithms, vectorized representation of the graph structured data needs to be calculated first, and then relevant tasks on the graph structured data are solved. In order to obtain the vectorized representation of the graph structured data, it is required to perform graph representation learning by using a deep neural network. The graph representation learning may be applied to a recommendation system, social-network analysis, biological molecular modeling, drug discovery, financial-market prediction and so on. Therefore, graph representation learning is an important scientific research issue. One type of existing graph representation learning method is graph neural network representation learning, in which a neighborhood aggregation mechanism is generally adopted to iteratively update representations of the nodes, and the representation of the whole is obtained by summarizing and aggregating the updated representations of the nodes according to a graph pooling method. Another type of existing graph representation learning method is a node-quantity-generalized graph neural network capable of migrating a model trained on a small graph to a large graph. Still another type of existing graph representation learning method is to analyze theoretically the capacity of solving a task through a neural network, and give a theoretical guarantee when distributions of a training set and a testing set are close.

In the related art, the first type of method has deteriorated effect when the distributions of the testing environment and the training environment are different. Therefore, the application scenes of the first type of method are limited to a certain extent, and the first type of method cannot be applied to real out-of-distribution generalized scenes. The second type of method merely adapts for cases where the quantities of node in the training environment and the testing environment change, and cannot adapt for changes of distributions of other types. Therefore, the second type of method cannot be applied to the graph representation learning of out-of-distribution generalization in real scenes either. The third type of method cannot be applied to cases where the training environment and the testing environment are different, and thus the obtained representation cannot accurately reflect the graph structured data located in the testing environment, which affects the performance of downstream tasks. The vectorized representation obtained according to the existing methods is obtained in a simulated training environment, without undergoing self-adapting processing for testing environments that are unknown and complicated and might have changing distribution. However, the graph structured data of the real world generally comes from complicated distributions, and when the training data cannot reflect the true distribution of the data, the testing data are different from the training data in the distributions. When a traditional training method is used, the training is terminated because the graph structure representation obtained has an excellent effect on the training dataset. However, when the graph structure representation is practically applied to a testing environment, the performance obviously deteriorates due to distribution shifts, whereby the performance is poor in different application scenes, and the difference between an execution result of the task and the true result is excessively large.

### SUMMARY

The embodiments of the present application provide a method and apparatus for learning graph representations for out-of-distribution generalization, a device and a storage medium.

A first aspect of the embodiments of the present application provides a method for learning graph representations for out-of-distribution generalization, including:
inputting an original graph dataset into a graph structured data representation network, where the graph structured data representation network includes a first graph neural network and a second graph neural network;
identifying a stable subgraph and a noise subgraph in each original graph structured data in the original graph dataset by performing identification on the original graph structured data via the first graph neural network, and obtaining identified graph structured data;
obtaining a vectorized representation of the stable subgraph and a vectorized representation of the noise subgraph by performing representation processing on the identified graph structured data via the second graph neural network;
simulating a multi-distribution environment according to the vectorized representation of the noise subgraph, and obtaining a corresponding prediction result by predicting in the multi-distribution environment according to the vectorized representation of the stable subgraph;
for each original graph structured data in the original graph dataset, calculating a loss function based on the prediction result and a label of the original graph structured data, performing parameter optimization on the graph structured data representation network, and obtaining a graph structured data representation model; and
executing a graph data-related task by using the graph structured data representation model, and obtaining a target result of the graph data-related task.

In some embodiments, the identifying a stable subgraph and a noise subgraph in each original graph structured data in the original graph dataset by performing identification on the original graph structured data via the first graph neural network includes:
obtaining graph structured data having updated node representation by updating node information of the original graph structured data;
obtaining, by calculating a similarity between nodes of the graph structured data having updated node representation, similarities between each node and neighborhood nodes in the graph structured data; and
selecting, according to the similarities, nodes having similarities greater than a preset similarity threshold and edges between the nodes to form the stable subgraph, and using remaining nodes and edges to form the noise subgraph.

In some embodiments, the obtaining graph structured data having updated node representation by updating node information of the original graph structured data includes:
acquiring node information of each node in the original graph structured data; and
obtaining the graph structured data having updated node representation by performing neighborhood aggregation on each node according to the node information of each node.

In some embodiments, the simulating a multi-distribution environment according to the vectorized representation of the noise subgraph, and obtaining a corresponding prediction result by predicting in the multi-distribution environment according to the vectorized representation of the stable subgraph, includes:
simulating the multi-distribution environment by performing clustering calculation on the vectorized representation of the noise subgraph; and
obtaining the corresponding prediction result by executing, according to the vectorized representation of the stable subgraph, a corresponding prediction task in the multi-distribution environment.

In some embodiments, for each original graph structured data in the original graph dataset, calculating a loss function based on the prediction result and a label of the original graph structured data, performing parameter optimization on the graph structured data representation network, and obtaining a graph structured data representation model, includes:
for each original graph structured data in the original graph dataset, calculating the loss function based on the prediction result and the label of the original graph structured data, and obtaining a corresponding loss value; and
obtaining the graph structured data representation model by performing gradient updating on the graph structured data representation network according to the loss value.

In some embodiments, the executing a graph data-related task by using the graph structured data representation model and obtaining a target result of the graph data-related task includes:
using the graph structured data representation model to receive a graph dataset corresponding to the graph data related task;
obtaining graph representation vectors corresponding to each graph structured data in the graph dataset by performing representation on the graph dataset; and
obtaining the target result by predicting, based on the graph representation vectors, with respect to a corresponding task target.

A second aspect of the embodiments of the present application provide an apparatus for learning graph representations for out-of-distribution generalization, including:
a data input module, configured to input an original graph dataset into a graph structured data representation network including a first graph neural network and a second graph neural network;
a data identification module, configured to: identify a stable subgraph and a noise subgraph in each original graph structured data in the original graph dataset by performing identification on the original graph structured data via the first graph neural network; and obtain identified graph structured data;
a representation processing module, configured to obtain a vectorized representation of the stable subgraph and a vectorized representation of the noise subgraph by performing representation processing on the identified graph structured data via the second graph neural network;
a result prediction module, configured to: simulate a multi-distribution environment according to the vectorized representation of the noise subgraph; and obtain a corresponding prediction result by predicting in the multi-distribution environment according to the vectorized representation of the stable subgraph;
a parameter optimization module, configured to: for each original graph structured data in the original graph dataset, calculate a loss function based on the prediction result and a label of the original graph structured data; perform parameter optimization on the graph structured data representation network; and obtain a graph structured data representation model; and
a task execution module, configured to execute a graph data-related task by using the graph structured data representation model, and obtain a target result of the graph data-related task.

In some embodiments, the data identification module includes:
a node updation submodule, configured to update node information of the original graph structured data, and obtain graph structured data having updated node representation;
a similarity calculating submodule, configured to obtain, by calculating a similarity between nodes of the graph structured data having updated node representation, similarities between each node and neighborhood nodes in the graph structured data; and
a subgraph determining submodule, configured to: select, according to the similarities, nodes having similarities greater than a preset similarity threshold and edges between the nodes to form the stable subgraph; and use remaining nodes and edges to form the noise subgraph.

In some embodiments, the node updation submodule includes:
a node information acquisition submodule, configured to acquire node information of each node in the original graph structured data; and
a neighborhood aggregation submodule, configured to obtain the graph structured data having updated node representation by performing, according to the node information of each node, neighborhood aggregation on each node.

In some embodiments, the result prediction module includes:
a clustering calculation submodule, configured to simulate the multi-distribution environment by performing clustering calculation on the vectorized representation of the noise subgraph; and
a prediction task execution submodule, configured to: execute, according to the vectorized representation of the stable subgraph, a corresponding prediction task in the multi-distribution environment, and obtain a corresponding prediction result.

In some embodiments, the parameter optimization module includes:
a loss value calculation submodule, configured to, for each original graph structured data in the original graph dataset, calculate a loss function based on the prediction result and the label of the original graph structured data, and obtain a corresponding loss value; and
a model obtaining submodule, configured to obtain the graph structured data representation model by performing, according to the loss value, gradient updation on the graph structured data representation network.

In some embodiments, the task execution module includes:
a data receiving submodule, configured to use the graph structured data representation model to receive a graph dataset corresponding to a graph data-related task;
a graph representation vector obtaining submodule, configured to obtain graph representation vectors corresponding to each graph structured data in the graph dataset by performing representation on the graph dataset; and
a target result obtaining submodule, configured to obtain the target result by performing a prediction, based on the graph representation vectors, with respect to a corresponding task target.

A third aspect of the embodiments of the present application provides a computer-readable storage medium storing a computer program that, when executed by a processor, implements the steps of the method according to the first aspect of the present application.

A fourth aspect of the embodiments of the present application provides an electronic device, including a memory, a processor and a computer program that is stored in the memory and is executable in the processor, the processor, when executing the computer program, implements the steps of the method according to the first aspect of the present application.

### BRIEF DESCRIPTION OF THE DRAWINGS

In order to more clearly illustrate technical solutions of the embodiments of the present application, drawings that are required to describe the embodiments of the present application will be briefly introduced below. Apparently, the drawings described below are embodiments of the present application, and those skilled in the art can obtain other drawings according to these drawings without paying creative work.

FIG. 1 is a flow chart of a method for learning graph representations for out-of-distribution generalization according to an embodiment of the present application;

FIG. 2 is a schematic diagram illustrating a flow of learning graph representations for out-of-distribution generalization according to an embodiment of the present application; and

FIG. 3 is a schematic diagram illustrating an apparatus for learning graph representations for out-of-distribution generalization according to an embodiment of the present application.

### DETAILED DESCRIPTION OF THE EMBODIMENTS

The technical solutions of the embodiments of the present application will be clearly and completely described below with reference to the drawings of the embodiments of the present application. Apparently, the described embodiments are merely certain embodiments of the present application, rather than all of the embodiments. All of the other embodiments that are obtained by those skilled in the art on the basis of the embodiments of the present application without paying creative work fall within the protection scope of the present application.

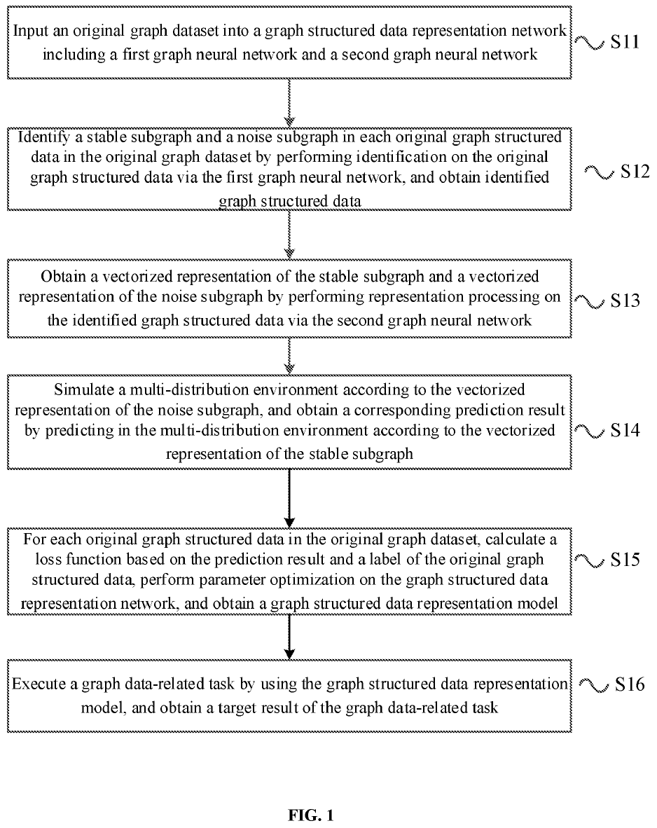

Reference is made to FIG. 1, that is a flow chart of a method for learning graph representations for out-of-distribution generalization according to an embodiment of the present application. As shown in FIG. 1, the method includes steps described below.

At S11, an original graph dataset is input into a graph structured data representation network, and the graph structured data representation network includes a first graph neural network and a second graph neural network.

In the present embodiment, the original graph dataset is a dataset including a large quantity of graph structured data. The graph structured data representation network refers to a deep neural network formed by the first graph neural network and the second graph neural network.

In the present embodiment, after being input into the graph structured data representation network, data in the original graph dataset is first processed by the first graph neural network, then a processing result of the first graph neural network is input into the second graph neural network to output the processing result by the second graph neural network.

As an example, the graph neural network may be a conventional graph neural network (GNN).

At S12, a stable subgraph and a noise subgraph in each original graph structured data in the original graph dataset are identified by performing identification on the original graph structured data via the first graph neural network, and identified graph structured data is obtained.

In the present embodiment, the graph structured data refers to graph data composed of nodes and edges, where a node represents a particular object, and an edge between two nodes represents the association between the objects. The stable subgraph refers to a subgraph formed by nodes and edges having a high relevance and a stable structure in the graph structured data. The noise subgraph refers to a subgraph formed by nodes and edges having a poor relevance and an unstable structure in the graph structured data. The stable subgraph and the noise subgraph are marked in the identified graph structured data.

As an example, the graph structured data may be a social-network relation graph, a traffic-network graph and so on. In a social-network relation graph, the nodes represent persons, and the edges represent relations between persons. In a traffic-network graph, the nodes represent subaerial buildings or locations, and the edges represent passages between the locations.

In the present embodiment, the step, in which a stable subgraph and a noise subgraph in each original graph structured data in the original graph dataset are identified by performing identification on the original graph structured data via the first graph neural network, and identified graph structured data is obtained, includes steps described below.

At S12-1, graph structured data having updated node representation is obtained by updating node information of the original graph structured data.

In the present embodiment, each node in the original graph structured data merely contains node information of itself, while the graph structured data have multiple hidden factors, which may be obtained by information interaction between the nodes. Updating node information means that each node updates the node information thereof according to information about its neighborhood nodes, and may be implemented by the following steps.

At S12-1-1, node information of each node in the original graph structured data is acquired.

In the present embodiment, the first neural network acquires, by reading the original graph structured data, the node information of each node in the original graph structured data. The node information may include any information that can be collected and stored, and any information that is relevant to the node and can be inquired may be saved as the node information of the node.

As an example, the social-network relation graph data is input into the network, and the first neural network reads the data of the relation graph to obtain the node information of each node in the social-network relation graph. The node information of each node includes any information relevant to the person such as the name, the gender, the age and the working place of the person.

At S12-1-2, the graph structured data having updated node representation is obtained by performing neighborhood aggregation on each node according to the node information of each node.

In the present embodiment, the neighborhood aggregation means updating, by each node, the node representation thereof according to the node information contained in the node's neighborhood nodes.

In the present embodiment, after obtaining the node information of each node, the first graph neural network updates the information of each node according to the information of each node and the neighboring nodes thereof, and generates the updated representation according to the updated node information.

As an example, in a social network, the node information on node A is (name: Wang Hong, gender: male, age: 30 years old, domicile city: Beijing), and the information on node B is (name: Wang Li, gender: female, age: 28 years old, spouse: Wang Hong). Accordingly, according to the node information on node A, it can be known that Wang Li on node B is the spouse of Wang Hong on node A. Accordingly, the domicile city of Wang Li on node B is also Beijing, and the spouse of Wang Hong on node A is updated as Wang Li. Subsequently, neighborhood aggregation is performed to node A and node B, thereby obtaining updated information on node A (name: Wang Hong, gender: male, age: 30 years old, spouse: Wang Li, domicile city: Beijing), and updated information on node B (name: Wang Li, gender: female, age: 28 years old, spouse: Wang Hong, domicile city: Beijing).

At S12-2, similarities between each node and neighborhood nodes in the graph structured data having updated node representation are obtained by calculating a similarity between nodes in the graph structured data having updated node representation.

In the present embodiment, the similarity between the nodes represents a similar degree of two nodes, if the similarity is higher, the information coinciding degree between two nodes is higher, and if the similarity is lower, the information coinciding degree between two nodes is lower.

As an example, in a social-network relation graph, the information on node A is (name: Wang Hong, Company: school A, occupation: teacher, working years: 10 years), the information on node B is (name: Zhang San, Company: school A, occupation: teacher, working years: 9 years), and the information on node C is (name: Li Si, Company: factory A, occupation: worker, working years: 15 years). Accordingly, as known from the similarity calculation, the similarity between node A and node B is high, and the similarity between node C and node A (or node B) is low.

At S12-3, the stable subgraph is formed by selecting, according to the similarities, nodes having similarities greater than a preset similarity threshold and edges between these nodes, and the noise subgraph is formed by using remaining nodes and edges.

In the present embodiment, the similarity threshold is a preset threshold, and is obtained by experimentation. The stable subgraph is a stable part of the graph structure, and does not change with the scene distribution. The noise subgraph is an unstable part of the graph structure, and easily changes with the scene distribution.

In the present embodiment, the first graph neural network will mark, according to the similarity between the nodes, the entire graph structured data, with edges between two nodes having similarity greater than the preset similarity threshold being marked as the edges of the stable subgraph, and the remaining edges being marked as the edges of the noise subgraph. The marked graph structured data are formed by two parts, i.e., the stable subgraph and the noise subgraph.

As an example, in an employee relation graph of a company, each node represents one employee. In the node information of each node, it is marked whether the employee is a permanent employee or a temporary worker. For example, the employees corresponding to nodes A, B and C are permanent employees, and the employees corresponding to nodes D and E are temporary workers. Apparently, employees A, B and C are more stable in the company, and the information similarities between these nodes are high. Therefore, the subgraph formed by nodes A, B and C is the stable subgraph. Employees D and E are unstable in the company, and the information similarities between these nodes are very low. Therefore, the subgraph formed by nodes D and E is the noise subgraph.

At S13, vectorized representation of the stable subgraph and vectorized representation of the noise subgraph are obtained by performing representation processing on the identified graph structured data via the second graph neural network.

In the present embodiment, after being marked by the first graph neural network, the graph structured data is input into the second graph neural network, and the second graph neural network performs representation processing on the marked graph structured data, to obtain the vectorized representation of the stable subgraph and the vectorized representation of the noise subgraph. For each graph structured data in the input dataset, after being processed by the second graph neural network, a corresponding vectorized representation of the stable subgraph and a corresponding vectorized representation of the noise subgraph can be obtained.

At S14, a multi-distribution environment is simulated according to the vectorized representation of the noise subgraph, and in the multi-distribution environment, a corresponding prediction result is obtained by predicting according to the vectorized representation of the stable subgraph.

In the present embodiment, the multi-distribution environment refers to an environment having multiple different types of data distribution.

In the present embodiment, the noise subgraph is the part of the graph data structure that might change at any time. Due to association between the noise information and the stable information in a graph data structure, the performance of the neural network is deteriorated when the distributions of the training environment and the testing environment are different. Through the second graph neural network, a multi-distribution environment is simulated according to the vectorized representation of the noise subgraph, and in the multi-distribution environment, a corresponding prediction result is obtained by predicting according to the vectorized representation of the stable subgraph, thereby realizing the training of the representation network of the entire graph structured data.

In the present embodiment, the step, in which a multi-distribution environment is simulated according to the vectorized representation of the noise subgraph, and in the multi-distribution environment, a corresponding prediction result is obtained by predicting according to the vectorized representation of the stable subgraph, comprises steps described below.

At S14-1, the multi-distribution environment is simulated by performing a clustering calculation on the vectorized representations of the noise subgraph.

In the present embodiment, the clustering calculation refers to clustering, according to the distances between the vectors, vectors that are close in terms of distance together.

In the present embodiment, the vectorized representations of the noise subgraph of the graph structured data in the dataset are clustered, and in response to the completion of the clustering, a multi-distribution environment is simulated. In the multi-distribution environment, the distributions of the data are diverse.

At S14-2, in the multi-distribution environment, a corresponding prediction task is executed according to the vectorized representation of the stable subgraph, and a corresponding prediction result is obtained.

In the present embodiment, by executing, according to the vectorized representation of the stable subgraph, a corresponding prediction task in the multi-distribution environment, among the information captured by the graph neural network, more attention is paid on information in the graph structured data that has a high influence on the true prediction result, and the noise information is neglected. The prediction task may be any prediction task relevant to the graph structured data, and may be customized.

As an example, a dataset includes multiple graph structured data, for example, a social-network relation graph, a person relation graph of a company and a person relation graph of a school. The noise data in these relation graphs is clustered by the second graph neural network, and a multi-distribution environment is simulated. As for the person relation graph of the company, a prediction task is to predict a trend of the average age of the employees. The stable subgraph is a subgraph formed by nodes corresponding to the permanent employees, and the noise subgraph is a subgraph formed nodes corresponding to temporary workers. Since the temporary workers will not necessarily still work in the company next year, they have an adverse effect on the prediction of the trend of the average age of the employees. The trend of the average age of the employees will be better predicted according to the stable subgraph.

In the present embodiment, in the multi-distribution environment, by enabling the stable subgraph to realize a stable prediction in the multi-distribution environment, among the information captured by the graph neural network, more attention is paid on the information in the graph structured data that has a prediction capability on true result, and the noise information is neglected. In this way, the model obtained by the training has a better representation effect and a better task execution effect.

At S15, for each original graph structured data in the original graph dataset, a loss function is calculated based on the prediction result and a label of the original graph structured data, and parameter optimization is performed on the graph structured data representation network to obtain a graph structured data representation model.

In the present embodiment, when the parameter optimization is performed on the graph structured data representation network, the entire network is iteratively updated according to the graph structured data in the input original graph dataset and their corresponding prediction result. When the parameters are adjusted to be optimum, the graph structured data representation model is obtained.

In the present embodiment, the step, in which, for each original graph structured data in the original graph dataset, a loss function is calculated based on the prediction result and a label of the original graph structured data, and parameter optimization is performed on the graph structured data representation network to obtain a graph structured data representation model, includes steps described below.

At S15-1, for each original graph structured data in the original graph dataset, a loss function is calculated according to the prediction result and the label of the original graph structured data, to obtain a corresponding loss value.

In the present embodiment, each of the original graph structured data for training the graph structured data representation network has a corresponding label, on which a correct prediction result is marked. When a corresponding prediction result is output from the second graph neural network, the loss function is calculated based on the prediction result and the prediction result marked on the label, to obtain a loss value.

At S15-2, a graph structured data representation model is obtained by performing, according to the loss value, gradient updating on the graph structured data representation network.

In the present embodiment, after the loss value is calculated, the loss value is fed back into the graph structured data representation network. The gradient value of parameters is obtained according to the calculated loss value by the graph structured data representation network, and gradient updating is performed on the graph structured data representation network, where the gradient updating is a gradient descent updating. Through the gradient descent updating, the loss value of the network is minimized, thereby achieving the parameter optimization of the graph structured data representation network. The graph structured data representation network obtained after the parameter optimization is the graph structured data representation network.

At S16, a graph data-related task is executed by using the graph structured data representation model, and a target result of the graph data-related task is obtained.

In the present embodiment, after the graph structured data representation model is obtained, any graph structured data that has not been labeled may be received, and a prediction task is executed by the following steps.

At S16-1, the graph structured data representation model is used to receive a graph dataset corresponding to the graph data related task.

In the present embodiment, the graph structured data representation model may be used to predict various tasks related to the graph data according to practical demands. For example, in a pharmaceutical analysis task, a molecular structure graph of a medicine may be input, and in a social-network analysis, a social-network graph may be input.

At S16-2, a graph representation vector corresponding to each graph structured data in the graph dataset is obtained by performing representation on the graph dataset.

At S16-3, a target result is obtained by performing a prediction, based on the graph representation vectors, with respect to a corresponding task target.

In the present embodiment, the graph structured data representation model may be used to perform vectorized representation on the input graph structured data, to obtain graph representation vectors, where the graph representation vectors contain vectorized representations of the stable subgraph in the graph structured data. According to the graph representation vectors, the task target is predicted to obtain the target result.

As an example, in a pharmaceutical analysis task, a molecular structure graph of a medicine is used to obtain the graph representation vectors of the graph data, and then the type of the medicine is predicted to obtain a prediction result.

In an embodiment of the present application, taking pharmaceutical analysis as an example, a model may be trained with a small quantity of molecule graphs labeled, and the model is applied to a larger quantity of unlabeled medicines, the data distributions of which are different that in the training, for classification. In a social-network analysis, an environmental self-adaptive graph representation can complete the analysis in a dynamical situation, an evolutionary situation and when the data distribution shifts, to give a sufficiently stable generalization result.

In the embodiments of the present application, the stable subgraph and the noise subgraph in the graph structured data are identified, the multi-distribution environment is simulated by using the vectorized representation of the noise subgraph, and the prediction task is executed according to the vectorized representation of the stable subgraph. In this way, the neural network pays more attention on the stable information of the graph structure itself, and the prediction result of the task is not influenced by the noise information, greatly improving the task execution performance of the entire model.

The method for learning graph representations for out-of-distribution generalization according to the present application includes: inputting an original graph dataset into a graph structured data representation network including a first graph neural network and a second graph neural network; identifying a stable subgraph and a noise subgraph in each original graph structured data in the original graph dataset by performing identification on the original graph structured data via the first graph neural network, and obtaining identified graph structured data; obtaining a vectorized representation of the stable subgraph and a vectorized representation of the noise subgraph by performing representation processing on the identified graph structured data via the second graph neural network; simulating a multi-distribution environment according to the vectorized representation of the noise subgraph, and obtaining a corresponding prediction result by predicting in the multi-distribution environment according to the vectorized representation of the stable subgraph; for each original graph structured data in the original graph dataset, calculating a loss function based on the prediction result and a label of the original graph structured data, performing parameter optimization on the graph structured data representation network, and obtaining a graph structured data representation model; and executing a graph data-related task by using the graph structured data representation model, and obtaining a target result of the graph data-related task. By the method for learning graph representations for out-of-distribution generalization according to the present application, the stable subgraph and the noise subgraph in the graph structured data are identified by performing identification on the received graph structured data, and the vectorized representation containing the representation of the stable subgraph and the representation of the noise subgraph is obtained. The noise subgraph is used to simulate the multi-distribution environment, and the model is encouraged to predict in the multi-distribution environment according to the stable subgraph. In this way, the stable information and the noise information in the graph structured representation are distinguished, separated and isolated. Therefore, spurious correlation in the representation is removed, thereby preventing the model from predicting based on the noise information, and finally encouraging the model to predict based on the stable information, self-adaptively ensuring the prediction effect of the model when the testing environment and the training environment have a difference in the distributions.

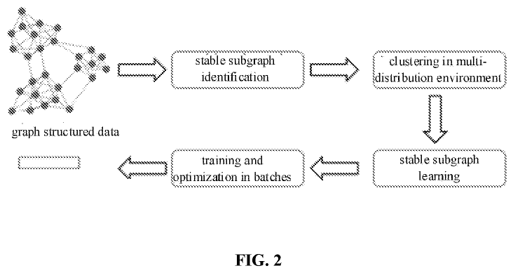

FIG. 2 is a schematic diagram illustrating a flow of learning graph representations for out-of-distribution generalization according to an embodiment of the present application. As shown in FIG. 2, after the graph structured data is input into the graph structured data representation network, the stable subgraph is identified first, then the multi-distribution environment is simulated by performing multi-distribution-environment clustering on the noise subgraph; subsequently, the stable subgraph is learned, and the task prediction is performed according to the stable subgraph; and a plurality of batches of the graph structured data are input into the graph structured data representation network to perform training and optimizing in batches. After the training of the graph structured data representation model is completed, the vector representation of out-of-distribution generalization can be obtained.

In the present embodiment, through the entire flow of the graph representation learning for out-of-distribution generalization, the vector representation of out-of-distribution generalization can be obtained. The vector representation of out-of-distribution generalization has a generalization property in a multi-distribution environment, and prediction results are still accurate in the multi-distribution environment, which ensures the accuracy of the prediction.

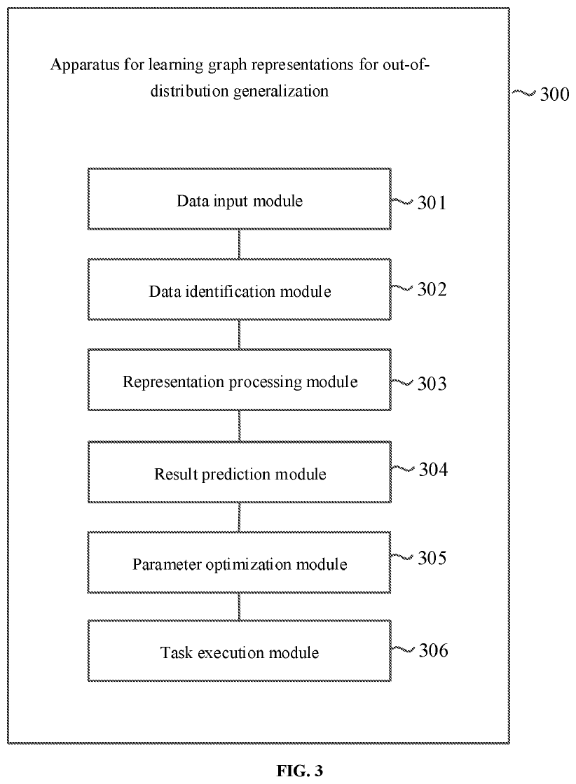

On the basis of the same inventive concept, an embodiment of the present application provides an apparatus for learning graph representations for out-of-distribution generalization. Referring to FIG. 3, FIG. 3 is a schematic diagram illustrating an apparatus 300 for learning graph representations for out-of-distribution generalization according to an embodiment of the present application. As shown in FIG. 3, the apparatus includes a data input module 301, a data identification module 302, a representation processing module 303, a result prediction module 304, a parameter optimization module 305 and a task execution module 306.

The data input module 301 is configured to input an original graph dataset into a graph structured data representation network, and the graph structured data representation network includes a first graph neural network and a second graph neural network.

The data identification module 302 is configured to identify a stable subgraph and a noise subgraph in each original graph structured data in the original graph dataset by performing identification on the first graph neural network, and obtain identified graph structured data.

The representation processing module 303 is configured to obtain vectorized representation of the stable subgraph and vectorized representation of the noise subgraph by performing a representation processing on the identified graph structured data via the second graph neural network.

The result prediction module 304 is configured to: simulate a multi-distribution environment according to the vectorized representation of the noise subgraph; and predict, according to the vectorized representation of the stable subgraph, in the multi-distribution environment, and obtain a corresponding prediction result.

The parameter optimization module 305 is configured to: for each original graph structured data in the original graph dataset, calculate a loss function based on the prediction result and a label of the original graph structured data; perform parameter optimization on the graph structured data representation network, and obtain a graph structured data representation model.

The task execution module 306 is configured to execute a graph data-related task, by using the graph structured data representation model, and obtain a target result of the graph data-related task.

In some embodiments, the data identification module includes:
a node updation submodule, configured to update node information of the original graph structured data, and obtain graph structured data having updated node representation;
a similarity calculating submodule, configured to calculate similarity between nodes of the graph structured data having updated node representation, and obtain similarities between each node and neighborhood nodes in the graph structured data; and
a subgraph determining submodule, configured to: select, according to the similarities, nodes having similarities greater than a preset similarity threshold and edges between the nodes to form the stable subgraph; and use remaining nodes and edges to form the noise subgraph.

In some embodiments, the node updation submodule includes:
a node information acquisition submodule, configured to acquire node information of each node in the original graph structured data; and
a neighborhood aggregation submodule, configured to obtain graph structured data having updated node representation by performing, according to the node information of each node, neighborhood aggregation on each node.

In some embodiments, the result prediction module includes:
a clustering calculation submodule, configured to simulate the multi-distribution environment by performing clustering calculation on the vectorized representation of the noise subgraph; and
a prediction task execution submodule, configured to: execute, according to the vectorized representation of the stable subgraph, a corresponding prediction task in the multi-distribution environment, and obtain a corresponding prediction result.

In some embodiments, the parameter optimization module includes:
a loss value calculation submodule, configured to, for each original graph structured data in the original graph dataset, calculate a loss function based on the prediction result and the label of the original graph structured data, and obtain a corresponding loss value; and
a model obtaining submodule, configured to obtain the graph structured data representation model by performing, according to the loss value, gradient updation on the graph structured data representation network.

In some embodiments, the task execution module includes:
a data receiving submodule, configured to use the graph structured data representation model to receive a graph dataset corresponding to a graph data-related task;
a graph representation vector obtaining submodule, configured to obtain graph representation vectors corresponding to each graph structured data in the graph dataset by representing the graph dataset; and
a target result obtaining submodule, configured to obtain the target result by performing a prediction, based on the graph representation vectors, with respect to a corresponding task target.

On the basis of the same inventive concept, another embodiment of the present application provides a computer-readable storage medium storing a computer program, that, when executed by a processor, implements the steps of the method for learning graph representations for out-of-distribution generalization according to any one of the above embodiments of the present application.

On the basis of the same inventive concept, another embodiment of the present application provides an electronic device, including a memory, a processor and a computer program that is stored in the memory and is executable in the processor. The computer program, when executed by the processor, implements the steps of the method for learning graph representations for out-of-distribution generalization according to any one of the above embodiments of the present application.

Regarding the device embodiments, because they are substantially similar to the process embodiments, they are described simply, and the related parts may refer to the description on the process embodiments.

The embodiments of the description are described in the mode of progression, each of the embodiments emphatically describes the differences from the other embodiments, and the same or similar parts of the embodiments may refer to each other.

Those skilled in the art should understand that the embodiments of the present application may be provided as a method, a device, or a computer program product. Therefore, the embodiments of the present application may take the form of a complete hardware embodiment, a complete software embodiment, or an embodiment combining software and hardware. Furthermore, the embodiments of the present application may take the form of a computer program product implemented on one or more computer-usable storage media (including but not limited to a disk storage, a CD-ROM, an optical memory and so on) containing a computer-usable program code therein.

The embodiments of the present application are described with reference to the flow charts and/or block diagrams of the method, the terminal device (system), and the computer program product according to the embodiments of the present application. It should be understood that each flow and/or block in the flow charts and/or block diagrams, and combinations of the flows and/or blocks in the flow charts and/or block diagrams, may be implemented by a computer program instruction. The computer program instructions may be provided to a processor of a general-purpose computer, a special-purpose computer, an embedded processor, or another programmable data processing terminal device to generate a machine, so that a device for implementing the functions specified in one or more flows of the flow charts and/or one or more blocks of the block diagrams can be generated by instructions executed by the processor of the computers or the other programmable data processing terminal device.

The computer program instructions may also be stored in a computer-readable memory that can instruct the computers or the other programmable data processing terminal device to operate in a specific mode, so that the instructions stored in the computer-readable memory generate an article comprising an instruction device, and the instruction device implements the functions specified in one or more flows of the flow charts and/or one or more blocks of the block diagrams.

The computer program instructions may also be loaded to the computers or the other programmable data processing terminal device, so that the computers or the other programmable data processing terminal device implement a series of operation steps to generate the computer-implemented processes, whereby the instructions executed in the computers or the other programmable data processing terminal device provide the steps for implementing the functions specified in one or more flows of the flow charts and/or one or more blocks of the block diagrams.

Although preferable embodiments of the embodiments of the present application have been described, once those skilled in the art has known the essential inventive concept, he may make further variations and modifications on those embodiments. Therefore, the appended claims are intended to be interpreted as including the preferable embodiments and all of the variations and modifications that fall within the scope of the embodiments of the present application.

Finally, it should also be noted that, in the present text, relation terms such as first and second are merely intended to distinguish one entity or operation from another entity or operation, and that does not necessarily require or imply that those entities or operations have therebetween any such actual relation or order. Furthermore, the terms “include”, “comprise” or any variants thereof are intended to cover non-exclusive inclusions, so that processes, methods, articles or terminal devices that include a series of elements do not only include those elements, but also include other elements that are not explicitly listed, or include the elements that are inherent to such processes, methods, articles or terminal devices. Unless further limitation is set forth, an element defined by the wording “comprising a . . . ” does not exclude additional same element in the process, method, article or terminal device comprising the element.

The method and apparatus for learning graph representations for out-of-distribution generalization, the device and the storage medium according to the present application have been described in detail above. The principle and the embodiments of the present application are described herein with reference to the particular examples, and the description of the above embodiments is merely intended to facilitate to understand the method according to the present application and its core concept. Moreover, for those skilled in the art, according to the concept of the present application, the particular embodiments and the range of application may be varied. In conclusion, the contents of the description should not be understood as limiting the present application.

What is claimed is:

1. A method for learning graph representations for out-of-distribution generalization, comprising:
inputting an original graph dataset into a graph structured data representation network, wherein the graph structured data representation network comprises a first graph neural network and a second graph neural network;
identifying a stable subgraph and a noise subgraph in each original graph structured data in the original graph dataset by performing an identification on the original graph structured data via the first graph neural network, and obtaining identified graph structured data;
obtaining a vectorized representation of the stable subgraph and a vectorized representation of the noise subgraph by performing representation processing on the identified graph structured data via the second graph neural network;
simulating a multi-distribution environment according to the vectorized representation of the noise subgraph, and obtaining a corresponding prediction result by predicting in the multi-distribution environment according to the vectorized representation of the stable subgraph;
for each original graph structured data in the original graph dataset, calculating a loss function based on the prediction result and a label of the original graph structured data, performing a parameter optimization on the graph structured data representation network, and obtaining a graph structured data representation model; and
executing a graph data-related task by using the graph structured data representation model, and obtaining a target result of the graph data-related task.

2. The method according to claim 1, wherein identifying the stable subgraph and the noise subgraph in each original graph structured data in the original graph dataset by performing the identification on the original graph structured data via the first graph neural network comprises:
obtaining graph structured data having an updated node representation by updating node information of the original graph structured data;
obtaining, by calculating a similarity between nodes of the graph structured data having the updated node representation, similarities between each node and neighborhood nodes in the graph structured data; and
selecting, according to the similarities, nodes having similarities greater than a preset similarity threshold and edges between the nodes to form the stable subgraph, and using remaining nodes and edges to form the noise subgraph.

3. The method according to claim 2, wherein obtaining the graph structured data having the updated node representation by updating node information of the original graph structured data comprises:
acquiring node information of each node in the original graph structured data; and
obtaining the graph structured data having updated node representation by performing neighborhood aggregation on each node according to the node information of each node.

4. The method according to claim 1, wherein simulating the multi-distribution environment according to the vectorized representation of the noise subgraph and obtaining the corresponding prediction result by predicting in the multi-distribution environment according to the vectorized representation of the stable subgraph comprises:
simulating the multi-distribution environment by performing clustering calculation on the vectorized representation of the noise subgraph; and
obtaining the corresponding prediction result by executing, according to the vectorized representation of the stable subgraph, a corresponding prediction task in the multi-distribution environment.

5. The method according to claim 1, wherein for each original graph structured data in the original graph dataset, calculating the loss function based on the prediction result and the label of the original graph structured data, performing the parameter optimization on the graph structured data representation network, and obtaining the graph structured data representation model comprises:
for each original graph structured data in the original graph dataset, calculating the loss function based on the prediction result and the label of the original graph structured data, and obtaining a corresponding loss value; and
obtaining the graph structured data representation model by performing gradient updating on the graph structured data representation network according to the loss value.

6. The method according to claim 1, wherein executing the graph data-related task by using the graph structured data representation model and obtaining the target result of the graph data-related task comprises:
using the graph structured data representation model to receive a graph dataset corresponding to the graph data related task;
obtaining graph representation vectors corresponding to each graph structured data in the graph dataset by performing representation on the graph dataset; and
obtaining the target result by predicting, based on the graph representation vectors, with respect to a corresponding task target.

7. A non-transitory computer-readable storage medium storing a computer program, wherein the computer program, when executed by a processor, implements operations of:
inputting an original graph dataset into a graph structured data representation network, wherein the graph structured data representation network comprises a first graph neural network and a second graph neural network;
identifying a stable subgraph and a noise subgraph in each original graph structured data in the original graph dataset by performing an identification on the original graph structured data via the first graph neural network, and obtaining identified graph structured data;
obtaining a vectorized representation of the stable subgraph and a vectorized representation of the noise subgraph by performing representation processing on the identified graph structured data via the second graph neural network;
simulating a multi-distribution environment according to the vectorized representation of the noise subgraph, and obtaining a corresponding prediction result by predicting in the multi-distribution environment according to the vectorized representation of the stable subgraph;
for each original graph structured data in the original graph dataset, calculating a loss function based on the prediction result and a label of the original graph structured data, performing a parameter optimization on the graph structured data representation network, and obtaining a graph structured data representation model; and
executing a graph data-related task by using the graph structured data representation model, and obtaining a target result of the graph data-related task.

8. An electronic device, comprising a memory, a processor, and a computer program that is stored in the memory and is executable in the processor, wherein the computer program, when executed by the processor, causing the electronic device to implement operations comprising:
inputting an original graph dataset into a graph structured data representation network, wherein the graph structured data representation network comprises a first graph neural network and a second graph neural network;
identifying a stable subgraph and a noise subgraph in each original graph structured data in the original graph dataset by performing an identification on the original graph structured data via the first graph neural network, and obtaining identified graph structured data;
obtaining a vectorized representation of the stable subgraph and a vectorized representation of the noise subgraph by performing representation processing on the identified graph structured data via the second graph neural network;
simulating a multi-distribution environment according to the vectorized representation of the noise subgraph, and obtaining a corresponding prediction result by predicting in the multi-distribution environment according to the vectorized representation of the stable subgraph;
for each original graph structured data in the original graph dataset, calculating a loss function based on the prediction result and a label of the original graph structured data, performing a parameter optimization on the graph structured data representation network, and obtaining a graph structured data representation model; and
executing a graph data-related task by using the graph structured data representation model, and obtaining a target result of the graph data-related task.

9. The electronic device according to claim 8, wherein the processor is further configured to perform operations of:
obtaining graph structured data having an updated node representation by updating node information of the original graph structured data;
obtaining, by calculating a similarity between nodes of the graph structured data having the updated node representation, similarities between each node and neighborhood nodes in the graph structured data; and
selecting, according to the similarities, nodes having similarities greater than a preset similarity threshold and edges between the nodes to form the stable subgraph, and using remaining nodes and edges to form the noise subgraph.

10. The electronic device according to claim 9, wherein the processor is further configured to perform operations of:
acquiring node information of each node in the original graph structured data; and
obtaining the graph structured data having updated node representation by performing neighborhood aggregation on each node according to the node information of each node.

11. The electronic device according to claim 8, wherein the processor is further configured to perform operations of:
simulating the multi-distribution environment by performing clustering calculation on the vectorized representation of the noise subgraph; and
obtaining the corresponding prediction result by executing, according to the vectorized representation of the stable subgraph, a corresponding prediction task in the multi-distribution environment.

12. The electronic device according to claim 8, wherein the processor is further configured to perform operations of:
for each original graph structured data in the original graph dataset, calculating the loss function based on the prediction result and the label of the original graph structured data, and obtaining a corresponding loss value; and
obtaining the graph structured data representation model by performing gradient updating on the graph structured data representation network according to the loss value.

13. The electronic device according to claim 8, wherein the processor is further configured to perform operations of:
using the graph structured data representation model to receive a graph dataset corresponding to the graph data related task;
obtaining graph representation vectors corresponding to each graph structured data in the graph dataset by performing representation on the graph dataset; and
obtaining the target result by predicting, based on the graph representation vectors, with respect to a corresponding task target.
